(19) United States
(12) Patent Application Publication
(10) Pub. No.: US 2024/0220962 A1
(43) Pub. Date: Jul. 4, 2024

(54) TRANSFERRING PAYMENTS USING SCANNED BARCODES

(71) Applicant: American Express Travel Related Services Company, Inc., New York, NY (US)

(72) Inventor: Edson MANCILLA, Los Angeles, CA (US)

(73) Assignee: American Express Travel Related Services Company, Inc., New York, NY (US)

(21) Appl. No.: 18/092,784

(22) Filed: Jan. 3, 2023

(51) Int. Cl. G06Q 20/32; G06Q 20/10; G06Q 20/38; G06Q 20/40

(52) U.S. Cl. CPC G06Q 20/3276; G06Q 20/102; G06Q 20/389; G06Q 20/405; G06Q 2220/00

(57) ABSTRACT

A system for making payments is disclosed. The system performs steps to at least receive a barcode with embedded information linking to a payee account capable of receiving a payment. Based on receiving the barcode a prompt for display on a browser of the user device can be generated, where the prompt requests identification of a financial institution connected to a user of the user device. The prompt can be transmitted to the user device. Identifying information identifying the financial institution can be received in response to the prompt. The financial institution can be accessed based on the response to the prompt. Based on accessing the user financial institution a request for the payment from the user financial institution to the payee account can be made.

### TECHNICAL FIELD

Aspects relate to payment systems.

### BACKGROUND

Conventionally, payments are made through bank wire transfers, credit cards, cash payments, or via mobile applications that a user needs to log into and perform a series of steps to initiate a payment. Each of these conventional methods has its downside and requires multiple manual steps to complete.

For example, a bank wire transfer requires a person to go to a bank or log into a bank's system to enter information about the recipient, sender, bank account to transfer to/from, amount to transfer, etc. Credit cards require physically being present at a point of sale (POS) device that can scan a credit card, or requires entering credit card information through a web interface to complete a payment. Cash payments require a person to be physically present to tender the cash to the recipient. Mobile applications require users of the application to log into the application and manually enter information about the recipient, bank account to transfer from/to, amount to transfer, etc.

An additional downside to many of these conventional methods is that they are not instantaneous. For example, bank wire transfers, credit card payments, and mobile transfers typically use the Automated Clearing House (ACH) payment network, which causes payments to be delayed by a few days before the recipient has access to the funds.

It would be convenient if there were a way to make instant payments without requiring a user to perform the steps of entering recipient information, transaction amount, etc., yet have the payment process be secure. Systems and methods are needed to address these issues.

### SUMMARY

Aspects disclosed herein provide a system and method for sending payments instantly and without a payer having to input payee information. The system and method achieves this through the use of optical labels. Optical labels, such as barcodes, represent data in a visual, machine-readable format. One type of barcode, known as linear or one-dimensional (1D) barcodes, can represent data by varying the widths and spacing of parallel lines. Another type of barcode, known as matrix codes, two-dimensional (2D) barcodes, or QR codes, use rectangles, dots, hexagons and other patterns to represent data.

Barcodes have many applications. In stores, universal product code (UPC) barcodes are pre-printed on most items and are used for inventory and to check out. Barcodes are also used in healthcare and hospital settings, for things like patient identification (to access patient data, including medical history, drug allergies, etc.). They can also be used to keep track of objects and people.

However, barcodes have not been as widely used in payment systems. Barcodes, however, have the property of allowing embedded information to be stored within the barcode. The embedded information can be used to process a payment for a payee. For example, a barcode can be generated for a merchant, a performer, a musician, etc. (i.e., a payee) by a financial institution. The barcode can have information regarding a financial account of the payee at the financial institution. The barcode can also have an embedded link to the financial account such that when a device (e.g., a mobile device) scans the barcode, it can connect a user of the device to the financial account, financial institution, or an interface that interfaces with the financial account and/or financial institution to perform a financial transaction. The disclosed system and method uses this mechanism to allow a payee to receive financial payments.

In aspects, the system can receive from a user device, a scanned barcode (i.e., a QR code) with embedded information linking to a payee account capable of receiving a payment. Based on receiving the barcode, a prompt can be generated for display on a browser of the user device. In aspects, the prompt can request identification of a financial institution connected to a user of the user device. In aspects, the prompt can be transmitted to the user device. The user can then identify the financial institution. The system can receive the identifying information identifying the financial institution in response to the prompt. Based on receiving the identifying information, the system can determine whether a software application connected to the identified financial institution is installed on the user device. In aspects, if determined that the software application is installed on the user device, the system can access the software application to access a user financial account accessible through the software application.

In aspects, if determined that the software application is not installed on the user device, the system can access the financial institution via an application programming interface (API) to access the user financial account. The API can be that of a third-party that interfaces with the financial institution to facilitate requesting the payment from the user financial account to the payee account. An example of such a third-party API is the API provided by PLAID Inc. of San Francisco, California, that can be used to connect banks to mobile applications.

Based on accessing the user financial account, the system can request the payment from the user financial account to the payee account. Based on requesting the payment, the system can receive, in real-time from when the request is made, the payment from the user financial account to the payee account as a push payment. The currency of the payment can be either a fiat currency or a cryptocurrency.

In aspects, instead of using a barcode, alternative tags or images can be used. For example, Near Field Communication (NFC) tags and SnapTags, can be used to initiate the payment. For example, a NFC tag can be printed as a vinyl tag and posted as a poster. In aspects, the user device can be equipped with a NFC reader and can be used to tap the NFC tag to initiate the same payment processes discussed above. The NFC reader can link to the financial institute of the payee, which can initiate the same set of prompts discussed. Alternatively, a SnapTag can be used as an alternative to QR codes to initiate the same processes.

In aspects, the payee account can include rules indicating a minimum amount for the payment accepted by the payee. Thus, when requesting the payment, the system can request at least the minimum amount as the payment.

In aspects, the payment can also be broken up into installments. Thus, when receiving the payment, the payment can be received as a payment stream with each payment being an installment. In aspects, a first installment of the installments can be received in real-time from when the request for the payment is made. In aspects, subsequent installments of the payment stream can be received at predetermined time intervals after the first installment is received.

Certain aspects of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

The accompanying drawings, which are incorporated herein and form a part of the specification, illustrate aspects of the present disclosure and, together with the description, further serve to explain the principles of the disclosure and to enable a person skilled in the pertinent art to make and use the disclosure.

FIG. 1 is a system for sending payments, according to aspects of the present disclosure.

FIG. 2 shows how a user of a client device scans a barcode to initiate payment to a payee, according to aspects of the present disclosure.

FIG. 3 shows an example prompt displayed on a web browser of the client device in response to the scanning of the barcode to initiate payment to the payee, according to aspects of the present disclosure.

FIG. 4 shows an interface requesting identification of a financial institution from which the payment is to be made from, according to aspects of the present disclosure.

FIG. 5 is a method of operating the system for sending payments, according to aspects of the present disclosure.

FIG. 6 is an example architecture of the components that can be used to implement the system, according to aspects of the present disclosure.

The drawing in which an element first appears is typically indicated by the leftmost digit or digits in the corresponding reference number. In the drawings, like reference numbers may indicate identical or functionally similar elements. The drawings are illustrative and may not be to scale.

### DETAILED DESCRIPTION

Aspects disclosed herein provide a system and method for sending payments. The system and method can initiate the payments to a payee when a user of a device scans a barcode of the payee to make a payment to the payee. The device can be any device capable of scanning a barcode, such as a mobile phone, a laptop computer, a camera, a smartwatch, augmented reality glasses, a barcode reader, etc. The system can connect the payee and the payer via the barcode to connect the payee and payer's financial accounts so that a financial transaction can take place. The system can perform the financial transaction in real-time from when the request to make the payment is initiated by the payer. How this is performed will be discussed further below.

The system is particularly useful for individuals that sell a product or service but do not have storefronts, access to point of sale (POS) devices, or credit card readers to collect payments. Typical use cases for the system can be for street performers, street musicians, street vendors, etc. The system allows such individuals to sell their products or services without the need to physically collect or process payments from payers. Rather, the payer can scan a barcode that is connected to the payee's financial account and can initiate a payment to the payee with minimal effort and without having to enter payee information. This is because the information needed to process the payment for the payee can be embedded within the barcode. This information can include a link to the financial account and institution of the payee, any minimum payment to be made, etc. The payer only has to indicate the financial institution he or she would like to make the payment from and/or any account that the funds are to come from. In aspects, the payer can enter a payment amount to override any minimum payment required by the payee. In aspects, the payment can be processed in real-time using a push payment network that can be used as a part of the system.

An example use case will be described for the system. Take, for example, the case of a street musician or street performer. Typically, a street musician or street performer performs for audiences on a street corner, park, sidewalk, etc. He or she can collect donations or payments from individuals that pass by observing the performance. Thus, he or she is not in a position to process payments while performing. Typically, donations are given in the form of cash and are put in a jar, collections basket, or instrument case during the performance. One issue is that many people do not carry cash with them. Thus, many individuals that would like to make donations to the performer cannot do so. However, many people have mobile devices capable of scanning barcodes.

Using the system, the street musician or street performer can instead of taking cash donations, create an account at a financial institution. The account can have an associated barcode. The street musician or street performer can print out the barcode and place it where individuals/users who want to make payments towards his or her performance can scan the barcode and be connected to the performers financial account and/or financial institution where the payment can be received.

In aspects, if an individual scans the barcode, the system can connect the individual to the performer's financial account and/or financial institution. To add security measures to the transaction, in aspects, a prompt can be generated by the system and can be displayed on a web browser of the device from which the individual scanned the barcode. In aspects, the prompt can request identification of a financial institution associated with the individual using the device. In aspects, the prompt or a separate prompt can also confirm that the individual wants to perform the transaction. Once the individual's financial institution is found and the transaction is confirmed, the payment can be requested by the system from the financial institution of the individual and sent through a push network that can connect the financial institution of the individual and the performer. The push network allows the payment to be processed in real-time.

The system provides several benefits over conventional systems. The system significantly reduces the barrier of making payments to payees that do not have access to storefronts, POS devices, credit card readers, etc., because it allows payees to transact without any hardware or software on their end. All payees need is a printout or a scannable copy of the barcode associated with their financial account. Additionally, the system also reduces the hardware or software for the payer, because all the payer needs is to have a device capable of scanning the barcode and that has access to the Internet. Such devices are ubiquitous and readily accessible to most individuals, as most individuals already have mobile devices that can be used for this purpose. Additionally, no particular software needs to be installed on the device. The only software needed is a web browser. Thus, financial transactions can be facilitated by the system with little to no additional hardware or software costs to both payee and payer.

Additionally, the payments can be done without any of the parties having to know the details of each other's financial institution or personal information. Conventional systems either require the payer to know the account information of the payee or to enter at least some personal information about the payee to find the payee (e.g., email address, phone number, etc.). The disclosed system does not require any such information. All the payer has to do is scan a barcode and answer a couple of prompts and the system does the rest of the processing. As a result, the system improves existing payment processing systems because it significantly reduces the number of steps required to perform a transaction and it also speeds up transaction times. This is also a security feature because input of wrong account numbers or payment information is minimized. Thus, the chances of performing a transaction with a party not intended to be transacted with is minimized. Moreover, because no personal information of the other party is needed by either the payee or payer to complete the transaction, the risk of a data breach is also minimized.

The system also improves the speed of transactions because it processes the transactions through a push network. Push networks are known to persons of skill in the art and will not be described in detail. For the purposes of discussion with respect to this disclosure, it is assumed that a push network can be used to process the payment such that the payment is processed in real-time from when the request for the payment is initiated by the payer.

### System Overview and Function

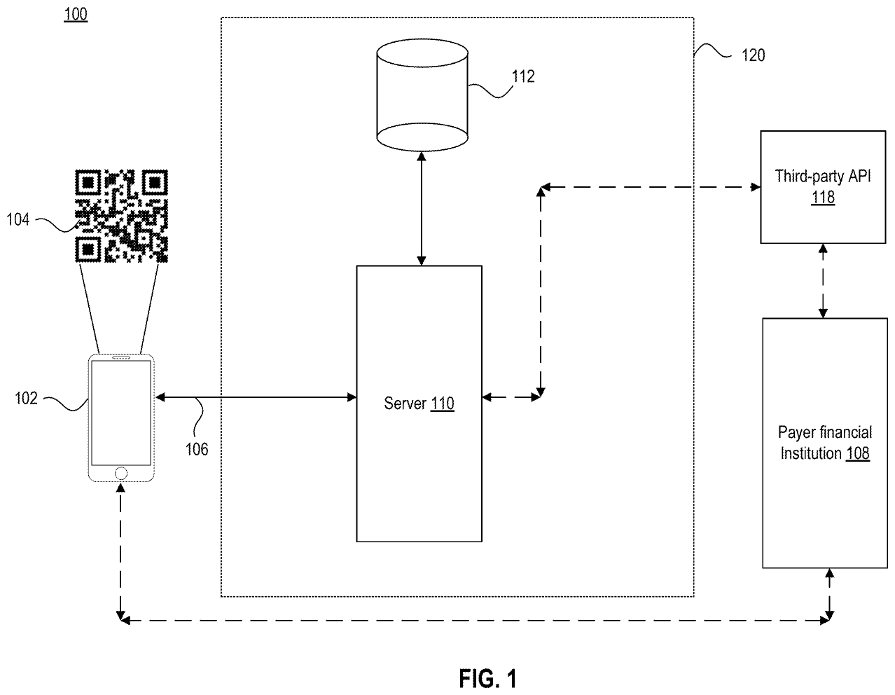

FIG. 1 is a system 100 for sending payments, according to aspects of the present disclosure. In aspects, the system 100 may be part of a backend computing infrastructure, including a server infrastructure of a company or institution. The backend computing infrastructure may be implemented in a cloud computing environment 120. The cloud computing environment 120 may be a public and/or private cloud service. Examples of a public cloud include Amazon Web Services (AWS), IBM Cloud, Oracle Cloud Solutions, Microsoft Azure Cloud, and Google Cloud, as examples. A private cloud refers to a cloud environment similar to a public cloud with the exception that it is operated solely for a single organization.

In aspects, the system 100 may be implemented using one or more servers. FIG. 1 shows server 110 that can have logic and/or software modules installed thereon that can implement the functions of the system 100. The logic and/or software modules can be stored on non-transitory computer readable medium that can be executable by one or more processors to implement the functionality of the system 100.

The server 110 may be a variety of centralized and/or decentralized computing devices. For example, the server 110 may be a mobile device, a laptop computer, a desktop computer, grid-computing resources, a virtualized computing resource, cloud computing resources, peer-to-peer distributed computing devices, a server farm, and/or a combination thereof. The server 110 may be centralized in a single room, distributed across different rooms, distributed across different geographic locations, and/or embedded within a network 106. The server 110 can couple with the network 106 to communicate with other devices, such as a client device 102.

The client device 102 may be any of a variety of devices, such as a smart phone, a cellular phone, a personal digital assistant, a tablet computer, a notebook computer, a laptop computer, a desktop computer, a smartwatch, a camera, augmented reality glasses and/or a headset, a barcode reader, and/or a combination thereof. The server 110 and the client device 102 may be stand-alone devices and work independently from one another.

The network 106 refers to a telecommunications network, such as a wired and/or wireless network. The network 106 can span and represent a variety of networks and network topologies. For example, the network 106 can include wireless communication, wired communication, optical communication, ultrasonic communication, and/or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in the network 106. Cable, Ethernet, digital subscriber line (DSL), fiber optic lines, fiber to the home (FTTH), and plain old telephone service (POTS) are examples of wired communication that may be included in the network 106. Further, the network 106 can traverse a number of topologies and distances. For example, the network 106 can include a direct connection, personal area network (PAN), local area network (LAN), metropolitan area network (MAN), wide area network (WAN), and/or a combination thereof.

How the system 100 operates will now be described. In aspects, system 100 can begin its operation when a user of the client device 102 scans a barcode 104 associated with payee. The user of the client device 102 can be a payer to the payee. Therefore, the terms user and payer will be used interchangeably throughout this disclosure. Such a transaction can include transferring currency to an account of the payee. the currency can be a fiat currency or a cryptocurrency.

As indicated, the payee can be any number of entities or individuals. For example, the payee can be a merchant, a performer, a musician, etc. The scan of the barcode 104 can be done using a barcode reader or camera of the client device 102. For the purposes of discussion, it is assumed that the client device 102 has either a barcode reader or camera that is integrated with the client device 102.

The barcode 104 can have information regarding a financial account of the payee at a financial institution. For the purposes of discussion with respect to this disclosure, it is assumed that the financial institution of the payee will be the one implementing the system 100 and that the server 110 discussed herein will be that of the financial institution. Thus, the financial institution will be the one that issues the barcode 104 for the payee.

The financial institution can be a bank, a credit agency, a brokerage, etc. In aspects, the barcode 104 can have an embedded link to the financial account and/or financial institution such that when the client device 102 scans the barcode 104, the barcode 104 can connect the client device 102 to the financial account, financial institution, and/or an interface that interfaces with the financial account and/or financial institution of the payee to perform a financial transaction between the payee and payer.

In aspects, once the barcode 104 is scanned, the information contained therein can enable a web browser installed on the client device 102 to link to a financial account and/or the financial institution of the payee. In aspects, this can be done by connecting to the server 110, which can link the client device 102 to the financial account and/or the financial institution. In other words, the scan of the barcode 104 can have a link to the server 110 that can connect the client device 102 to the financial account and/or financial institution of the payee. Similar processes can be initiated using NFC tags and SnapTags.

In aspects, the server 110 can use a database 112 to verify the payee's account and/or can access the payee's account to be connected to. The database 112 can be any storage medium and/or computer system that can hold information about the payee's account and can allow the server 110 to perform read, write, and data manipulation on the payee's account.

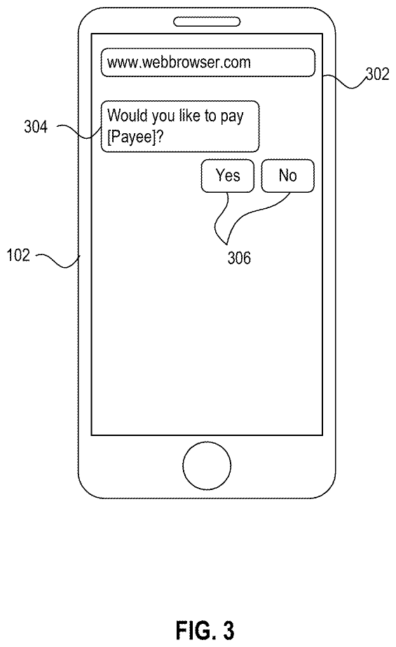

In aspects, and based on receiving the scan of the barcode 104, the server 110 can generate a prompt for display on the browser of the client device 102. The prompt can be transmitted to the client device 102 and can be displayed as a webpage or graphical user interface (GUI) displayed using the web browser of the client device 102. In aspects, the prompt can request that the user of the client device 102 verify that he or she wants to make the transaction to pay the payee. An example prompt is shown with respect to FIG. 3, which will be discussed further below. In aspects, the user of the client device 102 can perform the verification by clicking a button or icon indicating that he or she would like to perform the transaction. In aspects, the response to the prompt can be transmitted to the server 110, which can process the response to verify that the transaction is to proceed.

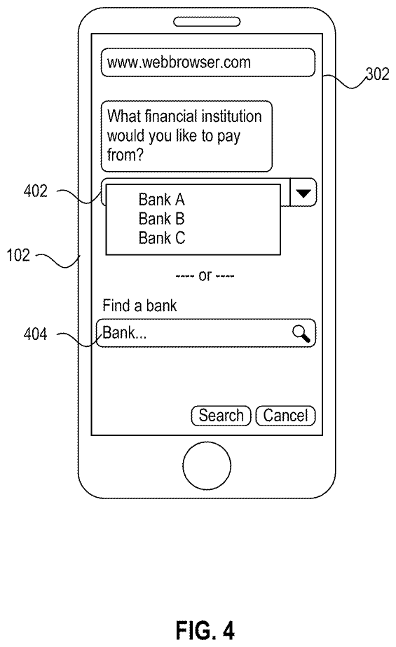

In aspects, once verified, the server 110 can generate a further prompt that can be transmitted to the client device 102. The further prompt can request identifying information identifying the payer financial institution 108 and/or account that the payment is to come from. An example of the further prompt is shown in FIG. 4, which will be discussed further below. In aspects, the user of the client device 102 can input the identifying information either by using a drop down list of financial institutions that he or she can choose from, or can manually enter a name of a financial institution as the payer financial institution 108 and search for the same. For the purposes of discussion, it is assumed that the user will be able to enter a payer financial institution 108 and/or account and that the same will be found by the system 100.

In aspects, based on receiving the identifying information, the server 110 can determine whether a software application connected to the identified payer financial institution 108 and/or account is installed on the client device 102. The purpose of doing this is to determine whether the software application on the client device 102 can be used to log into and access the payer financial institution 108 and/or the account at the payer financial institution 108. This is because typically a user that has a financial account will have a software application of the financial institution that the account is held at on their client device 102 that can be used to access the account (i.e., a mobile app). Such a software application can be used to log into the account using user credentials such as a username and password, biometric identification (i.e., face scan, finger scan, etc.), that can be stored on the client device 102.

In aspects, if determined that the software application is installed on the client device 102, the server 110 can access the software the application to access a user financial account accessible through the software application. In aspects, the user of the client device 102 may be asked to log into their account. In this way, the server 110 can access the account to make a request for payment from the payer financial institution 108.

In aspects, if determined that no software application is installed on the client device 102, the server can call on a third-party API 118 to access the user's financial account at the payer financial institution 108. The third-party API 118 can be that of a third-party that interfaces with the payer financial institution 108 to facilitate requesting the payment from the user financial account to the payee account. An example of such a third-party API 118 is the API provided by PLAID Inc. of San Francisco, California, that can be used to connect banks. These actions can be performed by the server 110 without the user of the client device 102 realizing that the third-party API 118 is being used to access the payer financial institution 108.

In aspects, and assuming that the payer financial institution 108 is accessed such that a payment can be initiated from the payer financial institution to the payee's financial institution, the server 110 can make a request via either the client device 102 and/or the third-party API 118 to initiate the payment from the payer financial institution 108 to the payee financial institution/account.

In aspects, once the request is made, and it is processed by the payer financial institution 108, the server 110 can receive the payment from the payer financial institution 108. In aspects, the payment can be processed using a push payment network of the system 100. Push payment networks are known to those of skill in the art. For the purposes of this disclosure, it is assumed that the push payment network can allow the payer financial institution 108 to directly “push” the payment to the payee's account in a direct bank-to-bank transfer. The push payment network can be, for example, the RTP® network from The Clearing House Payments Company L.L.C of New York, New York, that all federally insured U.S. depository institutions are eligible to use for payments innovation. Push networks such as the RTP® network provides consumers and businesses with the ability to conveniently send payments directly from their accounts at federally insured depository institutions twenty-four hours a day and seven days a week, and to receive and access funds sent to them over the RTP® network immediately, as opposed to in a batch basis like ACH and wire transfer. Also RTP® is available 24-7, as opposed to ACH and wire transfer which don't operate on weekends, bank holidays and outside business hours.

RTP® payments are processed by a The Clearing House server. For example, when paying a bill using RTP®, a bank sends message to network, which includes the details of the payment. The Clearing House server then processes the message and routes it to the payee's bank server, completing the payment. RTP® uses the ISO-20022 standard for the messages used to initiate payments and retrieve transaction status. ISO 20022 describes a collection of XML-based schemas that cover most types of financial messaging.

This allows for real-time transfers. In aspects, the push payment network can be implemented by the same financial institution that implements the system 100. The use of the push payment network allows the system 100 to near instantaneously transfer the payment from the payer to the payee (i.e. in real-time). Real-time refers to the payment being made within seconds or milliseconds from when the request for the payment is made from the payer financial institution 108.

Typically, payments made between accounts occur as lump sums. In aspects, the system 100 can allow for the payment to be made as a payment stream. The payment stream refers to a having the payment broken up into increments so that not all of the payment is made at once. The benefit of doing this is to allow the payer to make recurring payments in increments. This might be desirable in a situation where the payer does not have all the funds to pay the payee at once or has limits on transfers, and therefore needs to have the payment broken up into smaller bits and over a period of time.

In aspects, the payer can choose to have the payment stream done in installments by choosing, via an interface generated by the server 110 an option to make the payment in installments. In aspects, the installments can be set at predetermined time intervals chosen by the payer, and/or at predetermined time intervals that are present (e.g., over a period of minutes, hours, days, weeks, months, etc.). In aspects, the first installment of the installments can be received in real-time from when the request for the payment is made. However, subsequent installments after the first installment can be made according to the predetermined time intervals.

In aspects, the system 100 can also be set up such that the payee can set rules for his/her/its financial account such that the payee can set a minimum amount that will be accepted by the payee as a payment. In this way, the payee can use the rules to more predictably generate income. Thus, when a payment is initiated, the payment will be for at least the minimum amount set by the payee.

The functions described in FIG. 1 may be implemented as instructions stored on a non-transitory computer readable medium to be executed by one or more computing devices such as a processor, a special purpose computer, an integrated circuit, integrated circuit cores, and/or a combination thereof. The instructions may be implemented as software modules installed on the server 110. The non-transitory computer readable medium may be implemented with any number of memory units, such as a volatile memory, a nonvolatile memory, an internal memory, an external memory, or a combination thereof. The non-transitory computer readable medium may be integrated as part of the server 110, or installed as a removable portion of the server 110.

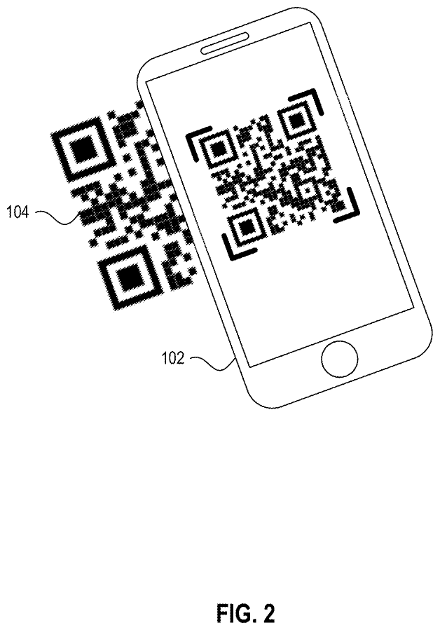

FIG. 2 shows how a user of the client device 102 scans the barcode 104 to initiate payment to a payee, according to aspects of the present disclosure. With respect to FIG. 2, the client device 102 is shown as a mobile phone. This is exemplary. In aspects, the client device 102 can have a camera and/or barcode scanner integrated therewith that can scan the barcode 104. In aspects, the barcode 104 can be scanned by framing the barcode 104 within a field of vision of the camera and/or barcode scanner such that it can be scanned. In aspects, the scanning of the barcode 104 can allow the client device 102 to recognize the embedded information in the barcode 104 can forward the scanned barcode 104 to link associated with the payee financial institution.

FIG. 3 shows an example prompt 304 displayed on a web browser 302 of the client device 102 in response to the scanning of the barcode 104 to initiate payment to the payee, according to aspects of the present disclosure. In aspects, and as described with respect to FIG. 1, prompt 304 can display a message to verify that the payer would like to make a payment to the payee. In aspects, the verification can be done by having the user click on buttons/icons 306 to perform the verification. FIG. 3 shows two buttons a “YES” and “NO” button that can be used. In aspects, a user can press the “YES” button to proceed with the payment or press “NO” to not proceed.

FIG. 4 shows an interface requesting identification of a financial institution from which the payment is to be made from, according to aspects of the present disclosure. In aspects, the interface can be shown on the web browser 302. In aspects, and as described with respect to FIG. 1, the interface can allow a payer to choose from which financial institution and/or financial account he or she would like to make the payment from. This can either be done via a drop down panel 402 listing various financial institutions that the user can choose from or by manually entering the financial institution name in a search box/window 404. Once input, the system 100 can search for and connect to the payer financial institution 108 (of FIG. 1) and/or account to request a payment to be made to the payee's financial institution/account.

### Methods of Operation

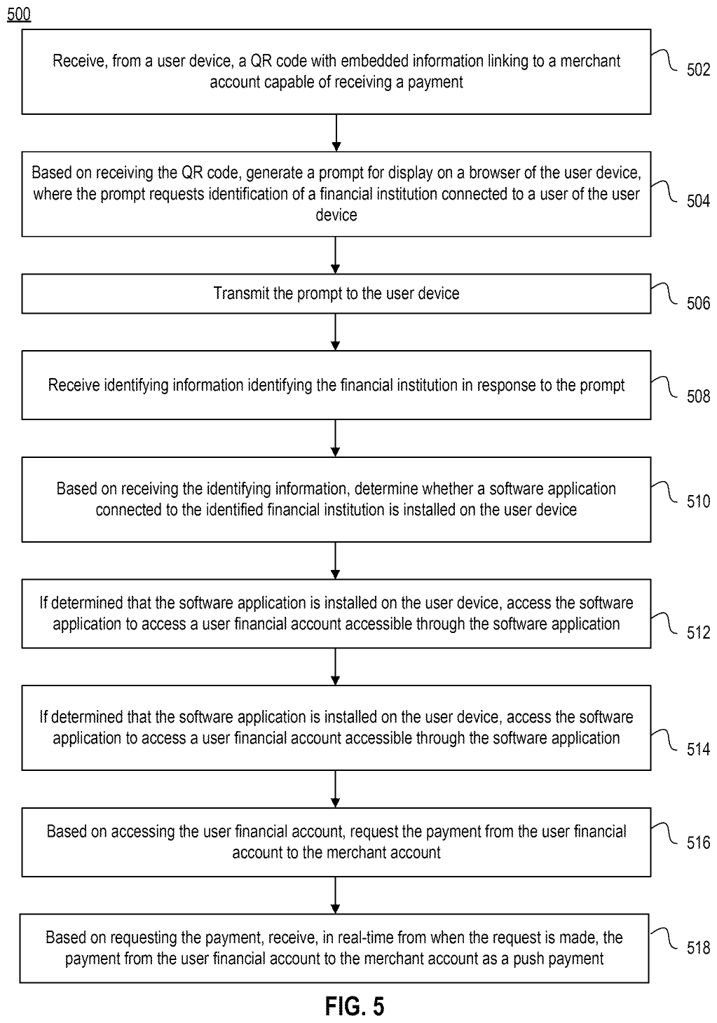

FIG. 5 is a method 500 of operating the system 100 for sending payments, according to aspects of the present disclosure. In aspects, method 500 can be performed by components of the system 100, such as the server 110 as described with respect to FIG. 1. Method 500 can be performed as a series of steps.

At step 502, server 110 can receive from a user device (e.g., client device 102), a barcode 104 (e.g., a QR code, a linear code, etc.) with embedded information linking to a payee account capable of receiving a payment. Alternatively a NFC tag or SnapTag can be used to receive similar information. At step 504, based on receiving the barcode 104 a prompt (e.g., prompt 304) can be generated for display on a browser (e.g., web browser 302) of the user device. The prompt can request identification of a financial institution connected to a user of the user device. At step 506 the prompt can be transmitted to the user device. At step 508, the server 110 can receive identifying information identifying the financial institution in response to the prompt. At step 510, based on receiving the identifying information, the server 110 can determine whether a software application connected to the identified financial institution is installed on the user device. At step 512, if determined that the software application is installed on the user device, the server 110 can access the software application to access a user financial account accessible through the software application. At step 514, if determined that the software application is not installed on the user device, the server 110 can access the financial institution via an application programming interface (API) to access the user financial account. At step 516, based on accessing the user financial account, the server 110 can request the payment from the user financial account to the payee account. At step 518, based on requesting the payment, the server 110 can receive and in real-time from when the request is made, the payment from the user financial account to the payee account as a push payment. In aspects, the push payment can then be applied to the payee's account. This can also be reflected by updating the database 112, which holds the account information of the payee's account.

The operation of method 500 is performed, for example, by system 100, in accordance with aspects described above.

### Components of the System

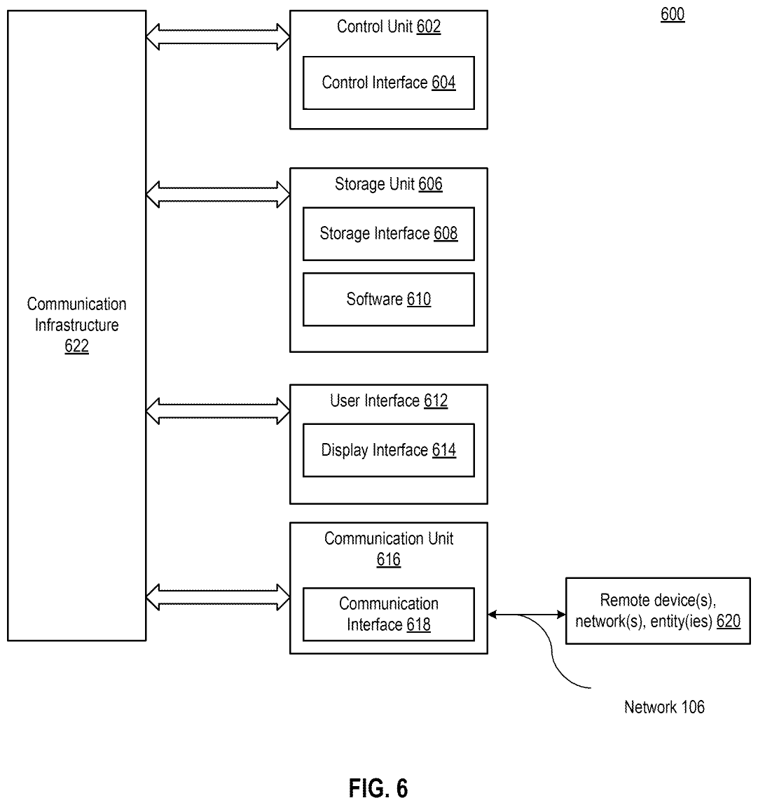

FIG. 6 is an example architecture 600 of the components that can be used to implement the system 100, according to aspects of the present disclosure. The components may be those of the server 110 and/or the client device 102. In many aspects, the components may include a control unit 602, a storage unit 606, a communication unit 616, and a user interface 612. The control unit 602 may include a control interface 604. The control unit 602 may execute a software 610 to provide some or all of the intelligence of system 100. The control unit 602 may be implemented in a number of different ways. For example, the control unit 602 may be a processor, an application specific integrated circuit (ASIC), an embedded processor, a microprocessor, a hardware control logic, a hardware finite state machine (FSM), a digital signal processor (DSP), a field programmable gate array (FPGA), and/or a combination thereof.

The control interface 604 may be used for communication between the control unit 602 and other functional units or devices of system 100. The control interface 604 may also be used for communication that is external to the functional units or devices of system 100. The control interface 604 may receive information from the functional units or devices of system 100, or from remote devices 620, and/or may transmit information to the functional units or devices of system 100, or to remote devices 620. The remote devices 620 refer to units or devices external to system 100.

The control interface 604 may be implemented in different ways and may include different implementations depending on which functional units or devices of system 100 or remote devices 620 are being interfaced with the control unit 602. For example, the control interface 604 may be implemented with a pressure sensor, an inertial sensor, a microelectromechanical system (MEMS), optical circuitry, waveguides, wireless circuitry, wireline circuitry to attach to a bus, an application programming interface, or a combination thereof. The control interface 604 may be connected to a communication infrastructure 622, such as a bus, to interface with the functional units or devices of system 100 or remote devices 620.

The storage unit 606 may store the software 610. For illustrative purposes, the storage unit 606 is shown as a single element, although it is understood that the storage unit 606 may be a distribution of storage elements. Also for illustrative purposes, the storage unit 606 is shown as a single hierarchy storage system, although it is understood that the storage unit 606 may be in a different configuration. For example, the storage unit 606 may be formed with different storage technologies forming a memory hierarchical system including different levels of caching, main memory, rotating media, or off-line storage. The storage unit 606 may be a volatile memory, a nonvolatile memory, an internal memory, an external memory, or a combination thereof. For example, the storage unit 606 may be a nonvolatile storage such as nonvolatile random access memory (NVRAM), Flash memory, disk storage, or a volatile storage such as static random access memory (SRAM) or dynamic random access memory (DRAM).

The storage unit 606 may include a storage interface 608. The storage interface 608 may be used for communication between the storage unit 606 and other functional units or devices of system 100. The storage interface 608 may also be used for communication that is external to system 100. The storage interface 608 may receive information from the other functional units or devices of system 100 or from remote devices 620, or may transmit information to the other functional units or devices of system 100 or to remote devices 620. The storage interface 608 may include different implementations depending on which functional units or devices of system 100 or remote devices 620 are being interfaced with the storage unit 606. The storage interface 608 may be implemented with technologies and techniques similar to the implementation of the control interface 604.

The communication unit 616 may allow communication to devices, components, modules, or units of system 100 or to remote devices 620. For example, the communication unit 616 may permit the system 100 to communicate between its components such as the server 110, the database 112, etc. The communication unit 616 may further permit the devices of system 100 to communicate with remote devices 620 such as the client device 102, the third party API 118, an attachment, a peripheral device, or a combination thereof through a network 106, such as a wireless or wired network.

As indicated with respect to FIG. 1, the network 106 may span and represent a variety of networks and network topologies. For example, the network 106 may be a part of a network and include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in the network 106. Cable, Ethernet, digital subscriber line (DSL), fiber optic lines, fiber to the home (FTTH), and plain old telephone service (POTS) are examples of wired communication that may be included in the network 106. Further, the network 106 may traverse a number of network topologies and distances. For example, the network 106 may include direct connection, personal area network (PAN), local area network (LAN), metropolitan area network (MAN), wide area network (WAN), and/or a combination thereof.

The communication unit 616 may also function as a communication hub allowing system 100 to function as part of the network 106 and not be limited to be an end point or terminal unit to the network 106. The communication unit 616 may include active and passive components, such as microelectronics or an antenna, for interaction with the network 106.

The communication unit 616 may include a communication interface 618. The communication interface 618 may be used for communication between the communication unit 616 and other functional units or devices of system 100 or to remote devices 620. The communication interface 618 may receive information from the other functional units or devices of system 100, or from remote devices 620, or may transmit information to the other functional units or devices of the system 100 or to remote devices 620. The communication interface 618 may include different implementations depending on which functional units or devices are being interfaced with the communication unit 616. The communication interface 618 may be implemented with technologies and techniques similar to the implementation of the control interface 604.

The user interface 612 may present information generated by system 100. In many aspects, the user interface 612 allows a user of system 100 to interface with the devices of system 100 or remote devices 620. The user interface 612 may include an input device and an output device. Examples of the input device of the user interface 612 may include a keypad, buttons, switches, touchpads, soft-keys, a keyboard, a mouse, or any combination thereof to provide data and communication inputs. Examples of the output device may include a display interface 614. The control unit 602 may operate the user interface 612 to present information generated by system 100. The control unit 602 may also execute the software 610 to present information generated by system 100, or to control other functional units of system 100. The display interface 614 may be any graphical user interface such as a display, a projector, a video screen, or any combination thereof.

The above detailed description and aspects of the disclosed system 100 are not intended to be exhaustive or to limit the disclosed system 100 to the precise form disclosed above. While specific examples for system 100 are described above for illustrative purposes, various equivalent modifications are possible within the scope of the disclosed system 100, as those skilled in the relevant art will recognize. For example, while processes and methods are presented in a given order, alternative implementations may perform routines having steps, or employ systems having processes or methods, in a different order, and some processes or methods may be deleted, moved, added, subdivided, combined, and/or modified to provide alternative or sub-combinations. Each of these processes or methods may be implemented in a variety of different ways. Also, while processes or methods are at times shown as being performed in series, these processes or blocks may instead be performed or implemented in parallel, or may be performed at different times.

The terms “module” or “unit” referred to in this disclosure can include software, hardware, or a combination thereof in an aspect of the present disclosure in accordance with the context in which the term is used. For example, the software may be machine code, firmware, embedded code, or application software. Also for example, the hardware may be circuitry, a processor, a special purpose computer, an integrated circuit, integrated circuit cores, or a combination thereof. Further, if a module or unit is written in the system or apparatus claims section below, the module or unit is deemed to include hardware circuitry for the purposes and the scope of the system or apparatus claims.

The modules or units in the following description of the aspects may be coupled to one another as described or as shown. The coupling may be direct or indirect, without or with intervening items between coupled modules or units. The coupling may be by physical contact or by communication between modules or units.

The resulting method 500 and system 100 is cost-effective, highly versatile, and accurate, and may be implemented by adapting components for ready, efficient, and economical manufacturing, application, and utilization. Another important aspect of aspects of the present disclosure is that it valuably supports and services the historical trend of reducing costs, simplifying systems, and/or increasing performance.

These and other valuable aspects of the aspects of the present disclosure consequently further the state of the technology to at least the next level. While the disclosed aspects have been described as the best mode of implementing system 100, it is to be understood that many alternatives, modifications, and variations will be apparent to those skilled in the art in light of the descriptions herein. Accordingly, it is intended to embrace all such alternatives, modifications, and variations that fall within the scope of the included claims. All matters set forth herein or shown in the accompanying drawings are to be interpreted in an illustrative and non-limiting sense. Accordingly, the scope of the invention should be determined not by the aspects illustrated, but by the appended claims and their equivalents.

What is claimed is:

1. A computer implemented method for sending payments, the method comprising:
receiving, by one or more computing devices and from a user device, an image of an optical label with embedded information linking to a payee account capable of receiving a payment;
based on receiving the image, generating, by the one or more computing devices, a prompt for display on a browser of the user device, wherein the prompt requests identification of a financial institution connected to a user of the user device;
transmitting, by the one or more computing devices, the prompt to the user device;
receiving, by the one or more computing devices, identifying information that identifies the financial institution in response to the prompt;
based on the receiving of the identifying information, determining, by the one or more computing devices, whether a software application connected to the identified financial institution is installed on the user device;
if determined that the software application is installed on the user device, accessing the software application to access a user financial account accessible through the software application;
based on accessing the user financial account, requesting, by the one or more computing devices, the payment from the user financial account to the payee account; and
based on requesting the payment, receiving, by the one or more computing devices and in real-time from when the request is made, the payment from the user financial account to the payee account as a push payment.

2. The method of claim 1, wherein a currency of the payment comprises: a fiat currency or a cryptocurrency.

3. The method of claim 1, wherein:
the payee account includes rules indicating a minimum amount for the payment accepted by the payee, and
wherein the method further comprises requesting, by the one or more computing devices, at least the minimum amount as the payment.

4. The method of claim 1, further comprising receiving, by the one or more computing devices, the payment as a payment stream.

5. The method of claim 4, further comprising:
receiving, by the one or more computing devices, the payment stream in installments, and
wherein a first installment of the installments is received in real-time from when the request is made.

6. The method of claim 5, further comprising receiving, by the one or more computing devices, subsequent installments of the payment stream at predetermined time intervals after the first installment is received.

7. The method of claim 1, wherein the API is a third-party API that interfaces with the financial institution to facilitate requesting the payment from the user financial account to the payee account.

8. A non-transitory computer readable medium having instructions stored thereon for sending payments that, when executed by a computing system, cause the computing system to perform operations comprising:
receiving, by one or more computing devices and from a user device, an image of an optical label with embedded information linking to a payee account capable of receiving a payment;
based on receiving the image, generating, by the one or more computing devices, a prompt for display on a browser of the user device, wherein the prompt requests identification of a financial institution connected to a user of the user device;
transmitting, by the one or more computing devices, the prompt to the user device;
receiving, by the one or more computing devices, identifying information that identifies the financial institution in response to the prompt;
based on the receiving of the identifying information, determining, by the one or more computing devices, whether a software application connected to the identified financial institution is installed on the user device;
if determined that the software application is installed on the user device, accessing the software application to access a user financial account accessible through the software application;
based on accessing the user financial account, requesting, by the one or more computing devices, the payment from the user financial account to the payee account; and
based on requesting the payment, receiving, by the one or more computing devices and in real-time from when the request is made, the payment from the user financial account to the payee account as a push payment.

9. The non-transitory computer readable medium of claim 8, wherein a currency of the payment comprises: a fiat currency or a cryptocurrency.

10. The non-transitory computer readable medium of claim 8, wherein:
the payee account includes rules indicating a minimum amount for the payment accepted by the payee, and
wherein the operations further comprise requesting, by the one or more computing devices, at least the minimum amount as the payment.

11. The non-transitory computer readable medium of claim 8, wherein the operations further comprise receiving, by the one or more computing devices, the payment as a payment stream.

12. The non-transitory computer readable medium of claim 11, wherein the operations further comprise:
receiving, by the one or more computing devices, the payment stream in installments, and
wherein a first installment of the installments is received in real-time from when the request is made.

13. The non-transitory computer readable medium of claim 12, wherein the operations further comprise receiving, by the one or more computing devices, subsequent installments of the payment stream at predetermined time intervals after the first installment is received.

14. The non-transitory computer readable medium of claim 8, wherein the API is a third-party API that interfaces with the financial institution to facilitate requesting the payment from the user financial account to the payee account.

15. A computing system for sending payments comprising:
a memory configured to store instructions; and
one or more processors, coupled to the memory and configured to process the stored instructions to:
receive, from a user device, an image of an optical label with embedded information linking to a payee account capable of receiving a payment,
based on receiving the image, generate prompt for display on a browser of the user device, wherein the prompt requests identification of a financial institution connected to a user of the user device,
transmit the prompt to the user device,
receive identifying information that identifies the financial institution in response to the prompt,
based on the receiving of the identifying information, determine whether a software application connected to the identified financial institution is installed on the user device,
if determined that the software application is not installed on the user device, access the financial institution via an application programming interface (API) to access the user financial account,
based on accessing the user financial account, request the payment from the user financial account to the payee account, and
based on requesting the payment, receive in real-time from when the request is made, the payment from the user financial account to the payee account as a push payment.

16. The computing system of claim 15, wherein a currency of the payment comprises: a fiat currency or a cryptocurrency.

17. The computing system of claim 15, wherein:
the payee account includes rules indicating a minimum amount for the payment accepted by the payee, and
wherein the one or more processors are further configured to request at least the minimum amount as the payment.

18. The computing system of claim 15, wherein the one or more processors are further configured to receive the payment as a payment stream.

19. The computing system of claim 18, wherein the one or more processors are further configured to:
receive the payment stream in installments, and
wherein a first installment of the installments is received in real-time from when the request is made.

20. The computing system of claim 15, wherein the API is a third-party API that interfaces with the financial institution to facilitate requesting the payment from the user financial account to the payee account.
